(19) United States
(12) Patent Application Publication
(10) Pub. No.: US 2008/0088397 A1
(43) Pub. Date: Apr. 17, 2008

(54) Control mechanism with an operating lever and a bearing ball with integrated permanent magnet

(75) Inventor: Steffen Kretschmer, Aschaffenburg (DE)

Correspondence Address: THE WEBB LAW FIRM, P.C., 700 KOPPERS BUILDING, 436 SEVENTH AVENUE, PITTSBURGH, PA, 15219, US

(73) Assignee: Linde Material Handling GmbH, Aschaffenburg (DE)

(21) Appl. No.: 11/891,054

(22) Filed: Aug. 8, 2007

(30) Foreign Application Priority Data
Aug. 10, 2006 (DE) 10 2006 037 526.2

(51) Int. Cl. G05G 9/053

(52) U.S. Cl. 335/205; 324/207.25

(57) ABSTRACT

A control mechanism has an operating lever (1) connected with a bearing ball (1a) with an integrated permanent magnet (4), the poles of which are located vertically one above the other, and which when the operating lever (1) is deflected move together with the bearing ball (1a). At least one contactless sensor (5) is provided for the measurement of a deflection of the operating lever (1) by measuring the orientation of the permanent magnet (4). The sensor (5) is located vertically underneath the bearing ball (1a) and immediately next to it.

### CROSS REFERENCE TO RELATED APPLICATION

This application claims priority to German Application No. 10 2006 037 526.2, filed Aug. 10, 2006, which application is herein incorporated by reference in its entirety.

### BACKGROUND OF THE INVENTION

1. Field of the Invention

This invention relates to a control mechanism with an operating lever that is connected with a bearing ball that has an integrated permanent magnet, the poles of which are located vertically one above the other, and which is rotated together with the bearing ball when the operating lever is deflected. The control mechanism has at least one contactless sensor for detection and measurement of a deflection of the operating lever by measuring the orientation of the permanent magnet.

2. Technical Considerations

A generic control mechanism is described in DD 253 496 A1. On this control mechanism, laterally next to the bearing ball there are two contactless sensors oriented at a right angle to each other, by means of which, when the operating lever is moved, changes in the position of a bar magnet which is integrated into the bearing ball are detected.

### SUMMARY OF THE INVENTION

It is an object of the invention to provide a control mechanism of the general type described above but which is more compact, includes fewer parts, and has a functionally reliable construction.

The invention teaches that the sensor is located vertically underneath the bearing ball and directly next to it.

In this arrangement, a single sensor located in the vicinity of the bottom pole of the permanent magnet is all that is necessary to detect and measure the deflection of the operating lever by measuring the orientation of the magnetic field of the permanent magnet. This arrangement also makes possible an extremely compact construction of the control mechanism.

In one advantageous realization of the invention, a second sensor is located vertically underneath the sensor and immediately next to it. This preferably congruent second sensor can be used for the redundant detection of the deflection of the operating lever. The signals generated by the sensors can thereby be in a specified relationship to each other. The result is a two-channel system.

The operating lever of the control mechanism can be made of non-magnetic material.

The operating lever and the spherical bearing set can be realized in one piece, and the bearing ball has a recess for the permanent magnet.

### BRIEF DESCRIPTION OF THE DRAWINGS

Additional advantages and details of the invention are explained in greater detail below with reference to the exemplary embodiment illustrated in the accompanying schematic drawings, in which:

FIG. 1 is a section through an exemplary control mechanism of the invention; and

FIGS. 2a-2d show the orientation of the lines of magnetic flux of the permanent magnet that is integrated into the bearing ball.

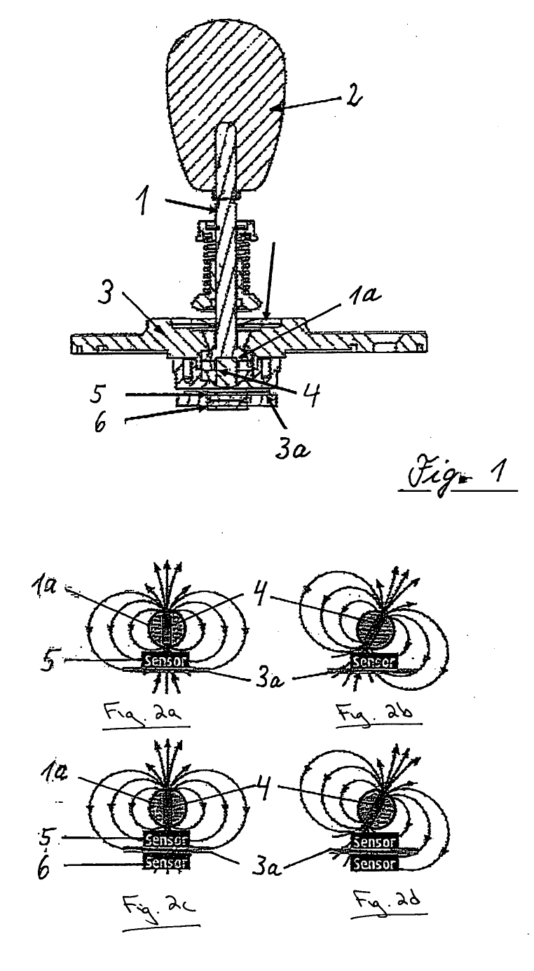

### DESCRIPTION OF THE PREFERRED EMBODIMENTS

The control mechanism, which can be used as a joystick, for example, to control the work functions (e.g., lifting and tilting movement of a lifting mechanism) of an industrial truck, has an operating lever 1 and a handgrip 2 that is located on the upper end. The operating lever 1 is connected on the lower end with a bearing ball 1a which is arranged in a housing 3 with an integrated sliding block guide of the operating lever 1. In the illustrated exemplary embodiment, the operating lever 1 and the bearing ball 1a are realized in one piece with each other and are made of a non-magnetic material. In a recess in the bearing ball 1a there is a permanent magnet 4 which is realized in the form of a bar magnet, i.e., it has poles that are located vertically one above the other.

The permanent magnet 4 that is integrated into the bearing ball 1a is at the center of rotation or near the center of rotation of the bearing ball 1a and is preferably located on the center axis of the operating lever 1. When the operating lever 1 is deflected, the permanent magnet 4 is rotated together with the bearing ball 1a in the housing 3.

Vertically underneath the bearing ball 1a, immediately next to it on a support plate 3a of the housing 3, there is a contactless sensor 5, which can be realized, for example, in the form of a Hall effect sensor. When the operating lever 1 is moved, the sensor 5 measures the change in the orientation of the permanent magnet 4 and/or of the magnetic field produced by this permanent magnet 4. Below the sensor 5, preferably congruently, there is a second sensor 6, by means of which the generation of a two-channel signal becomes possible, which achieves redundancy.

FIGS. 2a-2d show the orientation of the lines of magnetic flux of a magnetic field generated by the permanent magnet 4 for a control mechanism with only one sensor 5 (FIGS. 2a and 2b), and for a control mechanism with a first sensor 5 and a second sensor 6 (FIGS. 2c, 2d), each in the neutral position of the operating lever 1 (FIGS. 2a, 2c), and in a deflected position of the operating lever 1 (FIGS. 2b, 2d).

The control mechanism is a fully integrated, compact system which has a simple mechanical structure and only a few individual parts. The control mechanism offers good shielding capabilities against magnetic fields and EMV (electromagnetic vulnerability) interference fields. The measurement of the angle of the operating lever 1 is reliable and non-wearing. The control mechanism can also be used in harsh environments, because the control mechanism can be hermetically sealed.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. A control mechanism, comprising:
an operating lever connected with a bearing ball having an integrated permanent magnet, with the poles of the permanent magnet located vertically one above the other, wherein when there is a deflection of the operating lever, the permanent magnet is rotated together with the operating lever; and
at least one contactless sensor for detection and measurement of an orientation of the permanent magnet, wherein the at least one sensor is located vertically underneath the bearing ball and immediately next to it.

2. The control mechanism as recited in claim 1, including a first sensor located vertically underneath the bearing ball and immediately next to it and a second sensor located vertically underneath the first sensor and immediately next to it.

3. The control mechanism as recited in claim 1, wherein the operating lever is made of non-magnetic material.

4. The control mechanism as recited in claim 1, wherein the operating lever and the bearing ball are in one piece and the bearing ball has a recess for the permanent magnet.

5. The control mechanism as recited in claim 2, wherein the operating lever is made of non-magnetic material.

6. The control mechanism as recited in claim 2, wherein the operating lever and the bearing ball are in one piece and the bearing ball has a recess for the permanent magnet.

7. The control mechanism as recited in claim 3, wherein the operating lever and the bearing ball are in one piece and the bearing ball has a recess for the permanent magnet.

8. The control mechanism as recited in claim 5, wherein the operating lever and the bearing ball are in one piece and the bearing ball has a recess for the permanent magnet.
